(19) United States
(12) Patent Application Publication
(10) Pub. No.: US 2010/0204847 A1
(43) Pub. Date: Aug. 12, 2010

(54) WIRELESS INFRASTRUCTURE MESH NETWORK SYSTEM USING A LIGHTING NODE

(76) Inventors: Lawrence F. Leete, III, Spring Lake, MI (US); Thomas J. Doman, Holland, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 12/368,322

(22) Filed: Feb. 10, 2009

(51) Int. Cl. G06F 1/26; G06F 15/173

(52) U.S. Cl. 700/295; 709/252

(57) ABSTRACT

A wireless infrastructure network system (100) includes one or more first wireless transceivers (107) for communicating data through the wireless mesh network such that the first wireless transceivers (107) act solely to transmit and receive data. The mesh network system further includes one or more second wireless transceivers (101) for communicating data through the wireless mesh network system (100) such that the second wireless transceivers (101) are each integrated with an overhead task light (201). Operation of the overhead task light (201) is controlled through the wireless network enabling each individual overhead task light (201) to be easily controlled without the need for extensive control wiring to be added to each of the second wireless transceivers.

### FIELD OF THE INVENTION

The present invention relates generally to wireless infrastructure networks, such as a mesh network, and more particularly to a wireless mesh network node formed using an RF transceiver node and light fixture assembly.

### BACKGROUND

Various wireless infrastructure networking technologies are well-known in the art. Mesh networking is a way to route data, messages, voice, and/or instructions between nodes. It allows for continuous connections and reconfiguration around broken or blocked node-to-node links by “hopping” from node to node until the destination is reached. A mesh network whose nodes are all connected to each other is a fully connected network. Mesh networks differ from other networks in that the component parts can all connect to each other via multiple hops and they generally are not mobile. Mesh networks can be seen as one type of ad hoc network. Wireless applications of mesh networks add an even higher level of complexity in order to maintain reliable communication throughout the network.

Additionally, mesh networks are self-healing, such that a network can still operate even with a broken or faulty connection. As a result, a very reliable network is formed. This concept is applicable to wireless networks, wired networks, and software interaction. Today, wireless mesh networks are the most common of the mesh architectures. Wireless mesh was originally developed for military applications, but have undergone significant evolution in the past decade in order to accommodate personal and industrial applications.

There are many differing types of network applications involving lighting systems, such as U.S. Patent Publication US2007/0097993 to Bojahra et al. that teach a system for remote monitoring of local devices over a wide area network. A gateway device, such as a server or router, couples an external network via the Internet or local area network (LAN) used to monitor devices or switches. U.S. Pat. No. 6,160,359 to Fleischmann discloses a system for communicating with a remote computer to control an assigned lighting load that uses a local computer and virtual switch to communicate with a server for controlling a lighting load. Finally, U.S. Pat. No. 6,990,394 to Pasternak teaches a lighting control system that provides for the remote control of lighting using first and second wireless interfaces. Those skilled in the art will recognize that each of these representative patents or publications utilize nodes that act solely as a node and are not multifunctional for enhancing the utility of the mesh network in either a wired or wireless application.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is block diagram illustrating a wireless mesh network system using a lighting node operating as an integrated part of that light fixture in accordance with an embodiment of the invention.

FIGS. 2, 2A, and 2B are block diagrams illustrating a lighting node in accordance with an embodiment of the invention.

FIG. 3 is a block diagram of the lighting nodes used in combination forming a grid matrix on a ceiling.

FIG. 4 is a perspective view of a lamp node used in accordance with an embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to a wireless mesh network using a lighting node. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

It will be appreciated that embodiments of the invention described herein may be comprised of one or more conventional microprocessors and unique stored program instructions that control the microprocessors to implement, in conjunction with certain non-processor circuits, some, most, or all of the functions of a wireless mesh network using a task lighting node described herein. The non-processor circuits may include, but are not limited to, a radio receiver, a radio transmitter, signal drivers, clock circuits, power source circuits, and/or user input devices. As such, these functions may be interpreted as steps of a method to perform wireless mesh networking using a lighting node. Alternatively, some or all functions could be implemented by a state machine that has no stored program instructions, or in one or more application-specific integrated circuits (ASICs), in which each function or some combinations of certain functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

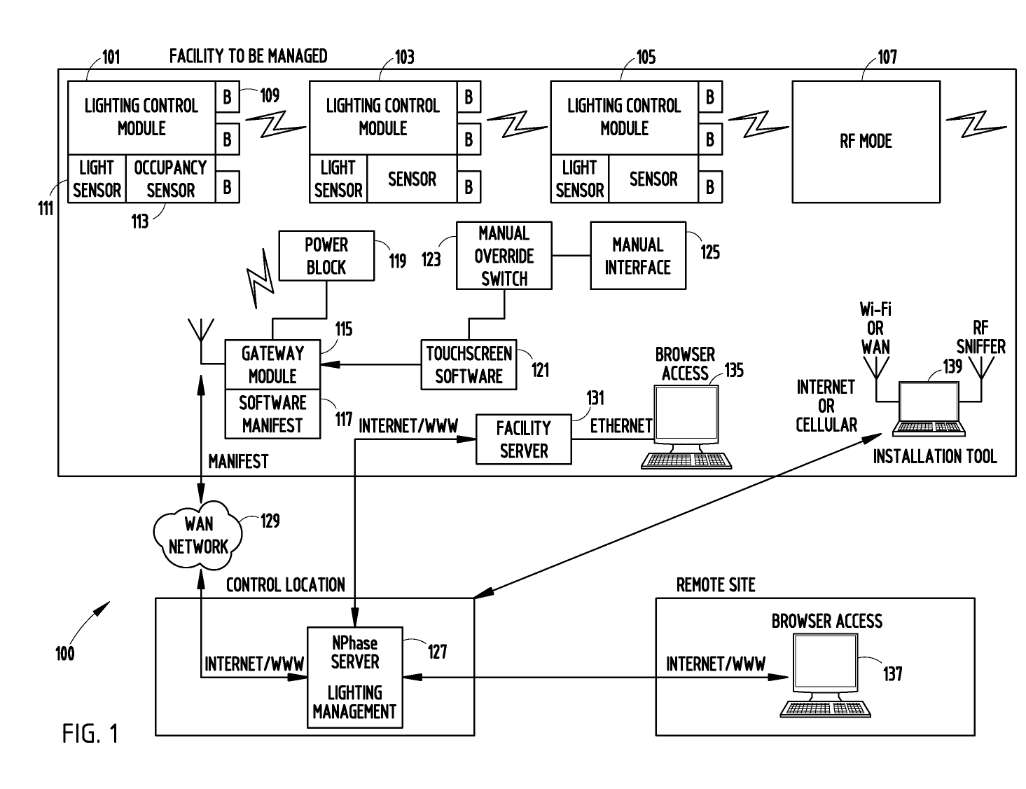

FIG. 1 illustrates a block diagram of a wireless infrastructure mesh network system using a lighting node in accordance with an embodiment of the invention. The wireless infrastructure mesh network system 100 includes a first group of nodes, such as wireless mesh network node 107 that operate to transmit and receive data and control instructions and other information through the mesh network system 100. The network further includes a second group of nodes, such as task lighting nodes 101, 103, and 105 that work to provide and project light in a work environment and whose functionality may be wirelessly controlled. In addition, the task lighting nodes 101, 103, 105 also operate to transmit control information and/or data from fixture-to-fixture. Moreover, each task lighting fixture 101 may include a single ballast or plurality of ballasts 109 that are used to supply a substantially high alternating current (AC) voltage to a plurality of lighting devices (not shown), such as fluorescent light bulbs or other devices providing a high number of lumens for lighting some predetermined space.

In addition, each fixture also possesses the ability to supply a radio frequency (RF) output for data, messages, and instructions to the mesh network. Each fixture 101 may further include such devices as a light sensor 111 that may be used to input detection information or other data into the mesh network. A mesh network control works then ultimately turn on or off lighting depending on user control input. Alternatively, in some applications, the intensity of a light may also be controlled by altering the amplitude and/or frequency of the voltage supplied to the ballast and/or lighting device, as described herein. Also, it will be evident to those skilled in that art that other types of sensing devices may be used in combination with the task lighting nodes 101, 103, 105 for detecting various parameters used in connection with the lighting node. For example, an occupancy sensor 113 can be used to detect when persons are in a certain proximity to the light fixture in order to control its operation. Hence, a single occupancy sensor 113 could be used by the mesh network to control a predetermined lighting footprint in the space used by the lighting node. Although only several nodes are shown in the mesh network system 100, it should be evident to those skilled in the art that mesh network will vary in size depending on the area that may need to be covered by the lighting nodes 101, 103, 105. Additionally, although occupancy sensor 113 is used in this example, many different types of sensors, as described herein, can be used depending on the environment upon which the lighting nodes 103, 105, 107 are used.

In order to centrally control the lighting nodes 101, 103, 105, and the RF node 107, a gateway control 115 is used that utilizes control software for providing operational control information and other data to one or more of the lighting fixtures 101, 103, 105 and the RF node 107. The control gateway 115 further includes a software module 117 for providing various control and operating instructions to the lighting fixtures as well as a power block 119. The power block 119 operates as the inbound power and neutral supply input lines (black and white) from the electrical grid. It is useful in situations or locations having varied or non-standard supply voltages from 120-277 VAC.

Thus, the gateway works as the proxy that communicates with a server that includes a “schedule and information” for passing changes and control information to and from the nodes as changes are made. Information is accrued by data mining at each node for determining how much energy is consumed, the operating bulb life, ballast life timers and monitors, asset tracking, people tracking, etc. The lighting fixture then sends this information back to the server as described herein.

The gateway module 115 further uses an RF transmitter and receiver (not shown) for communicating with one or more of the lighting nodes 101, 103, 105 and the RF node 107 using a ZigBee, EnOcean, Wi-Fi, or other RF networking protocol. Although the RF transmitter is not included in the gateway module 115, it may operate similarly to a touch screen control or other user interface device. The gateway module 115 further includes an internal battery similar to that of a computer for use with connection with an internal clock for maintaining system time in the event of a power outage.

Further, in order to provide override control of each of the lighting nodes 101, 103, 105 and RF node 107, a touch screen 121 can be used in combination with a wired manual override switch 123 that operates in combination with a manual interface 125 so that user instructions may be provided to each of the task lighting nodes 101, 103, 105 and RF node 107 in real time for overriding any pre-programmed software instructions that may be contained in the software manifest 117. The commands in the software manifest 117 are routinely sent to the gateway module 115 through a Wide Area network (WAN) 129, either wirelessly or through a hard wired connection. An external server 127 may also command and control the mesh network remotely using an external computer 137 through the Internet or using an external computer 139 connected using Wi-Fi or WAN wireless connection.

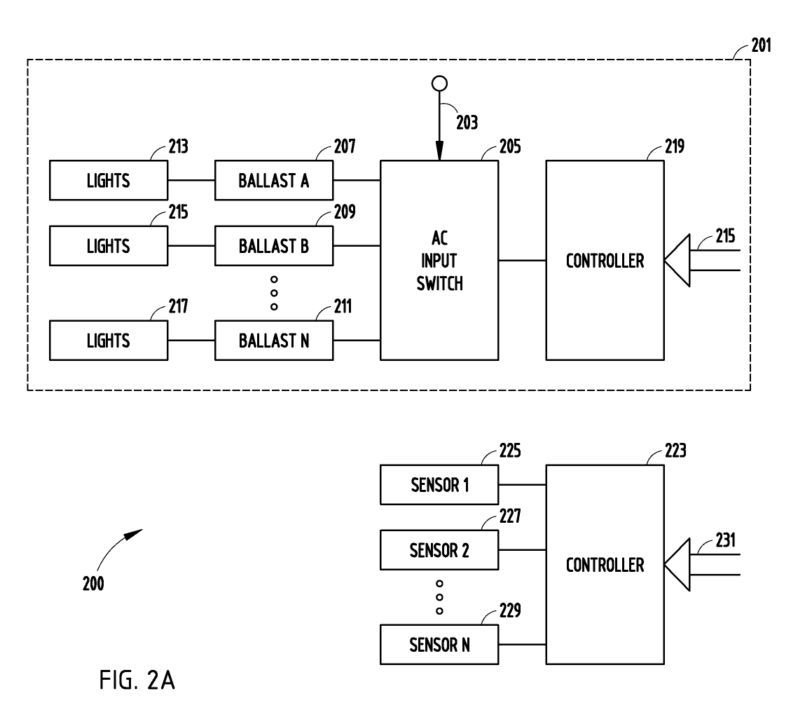

FIGS. 2, 2A, and 2B are block diagrams illustrating a task lighting mode in accordance with an embodiment of the invention. The task lighting node 200 includes a lighting subassembly 201 used for providing a voltage and light control to components of the light, and further includes an AC input 203 which is directed to an AC input switch 205. The AC input switch is an input to the controller. The electronic controller provides the individual drive voltages to the different ballasts. The AC input switch 205 may be an electrical or electronic switch for providing individual drive voltages to a series of ballasts, e.g., ballast A 207, ballast B 209, and ballast N 211. Each ballast operates by transforming or stepping up the AC voltage provided at its input so as to drive a series of lighting devices, such as bulbs 213, 215, 217. Each ballast 207, 209, 211 can use either an electrical transformer or switched solid state device for increasing the voltage amplitude and/or frequency to provide the appropriate drive to each of the bulbs 213, 215, 217. The drive voltage may be direct current (DC) or alternating current (AC) having some predetermined frequency such as 60 Hz or above.

FIG. 2B illustrates a block diagram of the RF node used in connection with the lighting node 200. Those skilled in the art will recognize that the invention is novel through the combination of an industrial/commercial type task lighting that is combined with an RF node enabling the light and node work in combination to create and control the RF infrastructure and network. The RF node and the lighting node are combined to form a novel invention forming both a task lighting node producing a technology “backbone” for allowing the control of other applications as described herein. The RF node 233 includes a processor memory that is used for controlling operation of RF communications from the node. The processor memory 235 utilizes a current sensing circuit 237 for detecting the amount of current drain as well as the overall power consumption associated with the lighting node and its associated lighting bulbs and ballasts.

The current sense circuitry 237 is connected with a series of control outputs that provide data over a bus 221 to a controller 219 within the node 201. Information regarding control of the lighting node and its associated current drain can be provided to the processor memory 235 where this information can be further transmitted using an RF transceiver 245 and antenna 247. Additionally, the lighting node 200 can further include one or more detectors and/or sensors 225, 227, 229 that are connected to a controller 223 whose data is supplied over bus 231 to a sensor input circuit 249. Data from sensors 225, 227, 229 can be transmitted to either a gateway control or other wired or wireless nodes in the network. Sensors 225, 227, 229 may include, but are not limited to, sensors for detecting occupancy, pipe integrity, air vents or valve positions, tank level, dynamic fluid flow and pressure, water detection, air quality, and/or ambient temperature. Each monitoring device can be a passive or active RFID device that will tie directly or integrate into the “mesh network” created by the task lighting node. This “backbone” can be used for enabling network communication as well as triangulating the locations.

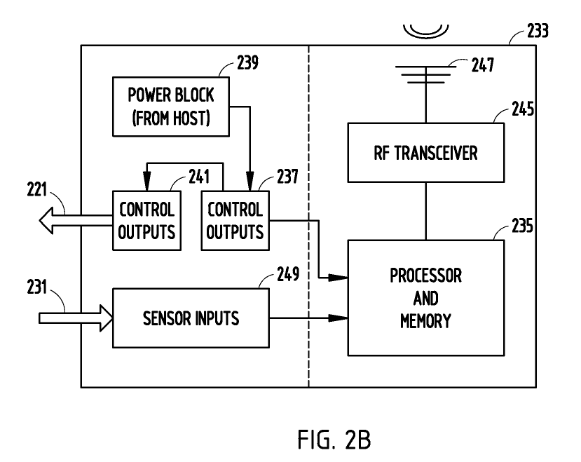

FIG. 3 illustrates the use of a plurality of lighting nodes forming a grid pattern. The grid pattern 300 includes grids 301, 303, 305, 307, 309, 311, 313, and 315 where data can be transmitted from node-to-node throughout the various grids. As seen in grid 301, each grid includes a plurality of lighting nodes 315 that work not only to provide light to a selected physical space, but they also work to communicate data using some predefined protocol from lighting node to lighting node throughout the grids. Each lighting node in the lighting grid can be individually controlled without the need for hardwired lighting control to be provided for each light. Moreover, sensors associated with each of the lighting nodes work to communicate data or control information back to a gateway as illustrated in FIG. 1. As will be evident to those skilled in the art, one superior advantage in such a networked grid pattern occurs in the event of a node malfunction or failure. Data can be easily re-routed around any malfunctioning node in order to maintain the integrity of the mesh network.

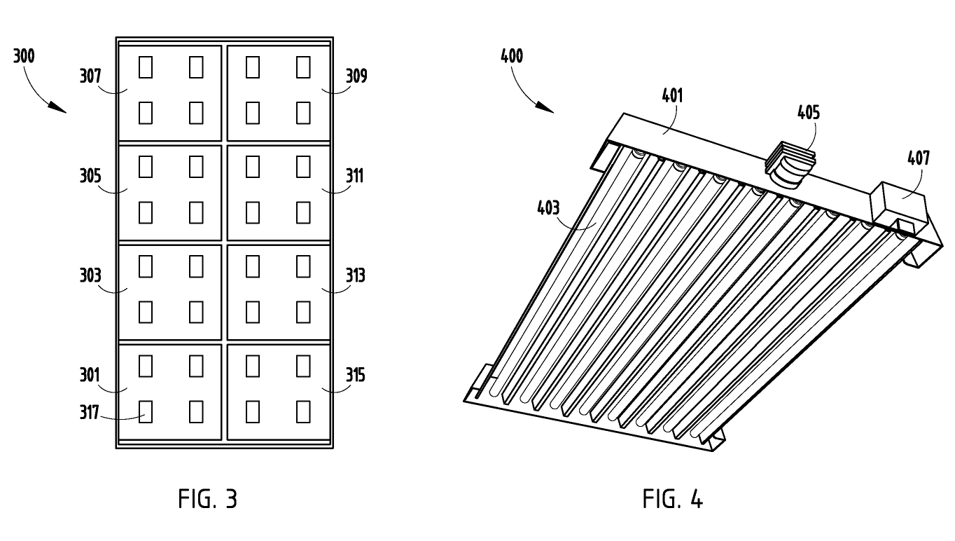

FIG. 4 illustrates a perspective view of a lighting node 400. The lighting node 400 includes a housing 401 as well as individual lights 403 included within the housing. An RF module 405, as illustrated in FIG. 2B, is attached to the side of the housing and works to provide RF communications to internal components located in the light. A proximity sensor 407 is also positioned at a strategic location on the housing which works to detect the presence of persons in the vicinity of light 400. In operation, the proximity sensor provides an input signal to the lighting node that is transferred into the mesh network's gateway. This results in turning on or off the task lighting in a predetermined behavior pattern to provide a factory space or other business with the most cost-efficient operation of the light.

Thus, an embodiment of the present invention is an integration of overhead task lighting with a wireless transceiver to provide a unique type of network nodes offering a number of novel attributes. The wireless mesh network system includes a group of networked wireless transceivers that are used for communicating data through the mesh network such that the first plurality of wireless transceivers acts solely as a transmitter and receiver. A second plurality of wireless transceivers are used for communicating data through the wireless mesh network such that the second plurality of wireless transceivers are each integrated with an overhead task light. The overhead task light includes a current sensing device and at least one ballast for controlling brightness of one or more bulbs and/or lighting devices providing illumination.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, or solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

We claim:

1. A wireless infrastructure mesh network system comprising:
a first plurality of wireless transceivers for communicating data through the wireless mesh network such that the first plurality of wireless transceivers acts solely to transmit and receive data;
a second plurality of wireless transceivers for communicating data through the wireless mesh network such that the second plurality of wireless transceivers are each integrated with an overhead task light; and
wherein operation of the overhead task light is controlled through the wireless network.

2. A wireless infrastructure mesh network system as in claim 1, further comprising:
a current sensing device associated with the overhead task light for detecting operational parameters of the overhead task light.

3. A wireless infrastructure mesh network system as in claim 2, wherein the operational parameters are used by a gateway control for controlling the power consumption of the overhead task light.

4. A wireless infrastructure mesh network system as in claim 2, further comprising at least one switch for controlling voltage supplied to the at least one ballast.

5. A wireless infrastructure mesh network system as in claim 2, wherein the at least one current sensing device controls voltage amplitude supplied to the at least one ballast.

6. A wireless infrastructure mesh network system as in claim 2, wherein the at least one current sensing device controls the voltage frequency supplied to the at least one ballast.

7. A wireless infrastructure mesh network system as in claim 1, further comprising at least one sensor for transmitting data to a control gateway which includes at least one from the group of: occupancy detector, pipe integrity detector, air vent detector, valve position detector, tank level detector, dynamic fluid flow detector, pressure detector, water detector, air quality detector, and temperature detector.

8. A wireless infrastructure mesh network system as in claim 1, wherein the first plurality of wireless transceivers and second plurality of wireless transceivers use a ZigBee protocol.

9. A wireless mesh network system comprising:
a first transceiver operating as a transmitter and receiver for communicating with nodes in mesh network;
a second transceiver operating as a transmitter and receiver and including a multifunction light fixture for providing light to a workspace; and
wherein the multifunction light fixture includes a current detector for sensing power consumption of at least one ballast used with the multifunction light such that light emissions can be controlled using control information transmitted to a second transceiver.

10. A wireless mesh network system as in claim 9, further comprising at least one switch for controlling voltage supplied to the at least one ballast.

11. A wireless mesh network system as in claim 9, wherein the current detector controls voltage amplitude supplied to the at least one ballast.

12. A wireless mesh network system as in claim 9, wherein the at least one current sensing device controls the voltage frequency supplied to the at least one ballast.

13. A wireless mesh network system as in claim 9, further comprising at least one sensor for transmitting data to a control gateway which includes at least one from the group of: occupancy detector, pipe integrity detector, air vent detector, valve position detector, tank level detector, dynamic fluid flow detector, pressure detector, water detector, air quality detector, and temperature detector.

14. A wireless mesh network system as in claim 9, wherein the first transceiver and second transceiver use a ZigBee protocol.

15. A lighting node for use in a wireless communications network comprising:
at least one lighting device for providing illumination;
at least one ballast for providing a voltage to the at least one lighting device;
a controller for controlling operation of the at least one ballast; and
a wireless transceiver connected to the at least one controller for controlling operation of the at least one lighting device and providing networking communication to other lighting nodes.

16. A lighting node as in claim 15, wherein the at least one lighting device is a fluorescent bulb.

17. A lighting node as in claim 15, further comprising at least one switch for controlling power supplied to the at least one ballast.

18. A lighting node as in claim 15, further comprising:
a current sensing device connected to the at least one ballast for detecting operational parameters of the at least one lighting device.

19. A lighting node as in claim 18, wherein the operational parameters include detecting power consumption of the at least one lighting device.

20. A lighting node as in claim 18, wherein the at least one current sensing device controls voltage amplitude supplied to the at least one ballast.

21. A lighting node as in claim 18, wherein the at least one current sensing device controls the voltage frequency supplied to the at least one ballast.

22. A lighting node as in claim 15, further comprising at least one sensor connected with the controller for transmitting data to a control gateway where the at least one sensor from the group of: occupancy detector, security detector, pipe integrity detector, air vent detector, valve position detector, tank level detector, dynamic fluid flow detector, pressure detector, water detector, air quality detector, and temperature detector.

23. A lighting node as in claim 15, wherein the wireless transceiver utilizes a ZigBee protocol.
